(19) United States
(12) Patent Application Publication
(10) Pub. No.: US 2023/0085557 A1
(43) Pub. Date: Mar. 16, 2023

(54) ACTIVE COMPONENT DELIVERY SYSTEMS

(71) Applicant: Givaudan SA, VERNIER (CH)

(72) Inventors: Robert GUISINGER, Cincinnati, OH (US); Stephen FERGUSON, Cincinnati, OH (US); Moises GALANO, Sao Paolo (BR); David SIEGEL, Cincinnati, OH (US)

(21) Appl. No.: 17/796,320

(22) PCT Filed: Feb. 23, 2021
(86) PCT No.: PCT/EP2021/054431

§ 371 Date: Jul. 29, 2022

Related U.S. Application Data
(60) Provisional application No. 62/980,511, filed on Feb. 24, 2020.

(51) Int. Cl. A23L 27/00; A23L 2/56; A23P 10/30

(52) U.S. Cl. CPC A23L 27/72; A23L 2/56; A23P 10/30

(57) ABSTRACT

Encapsulated active components for delivering a desired amount of the active component includes at least one active component encapsulated within a delivery vehicle obtained by cryogenically treating plant material. The active may be a desired flavor that is added to a consumable base to prepare a consumable product, such as food or beverage product, or to prepare an oral care product. Methods for making the delivery systems containing the active component and products containing the encapsulated active component delivery systems are also disclosed.

### TECHNICAL FIELD

The present disclosure relates to active component delivery systems based on cryogenically treated plant material, methods for making the active component delivery systems, compositions, formulations and products containing the active component delivery system, and methods for preparing compositions, formulations and products containing the active component delivery system. The present disclosure more particularly relates to flavor and fragrance delivery systems based on cryogenically treated plant material, methods for making flavor delivery systems based on cryogenically treated plant material, methods for making fragrance delivery systems based on cryogenically treated plant material, compositions, formulations and products containing the flavor delivery system, compositions, formulations and products containing the fragrance delivery system, methods for making compositions, formulations and products containing the flavor delivery system, and methods for making compositions, formulations and products containing the fragrance delivery system.

### BACKGROUND

Encapsulating active components, such as volatile active components, in a solid encapsulating matrix is a well-known method. The advantages are numerous and include, for example, (i) the protection of the volatile component against undesired evaporation during storage, (ii) the protection of chemically sensitive components against chemical degradation, such as oxidation and hydrolysis, and (iii) the possibility to control the release of the encapsulated component.

Numerous methods can be used to produce solids comprising encapsulated volatile ingredients. However, the most common and economical way to encapsulate a volatile component involves the step of emulsifying the volatile component in an aqueous phase comprising encapsulating materials to form an oil-in-water emulsion and drying this emulsion by spray drying, spray granulation, or spray coating to obtain a dry emulsion. The morphology of the dry product is that of a multitude of oil droplets in a glassy, polar, encapsulating matrix. The polar, encapsulating matrix is usually based on carbohydrate materials, such as modified starches, maltodextrins, and gums.

Oil bodies, also known as oleosomes, are spherical plant cell organelles. Oil bodies are generally found in oleaginous (ie, oil-bearing) plant seeds. Oil bodies are micron-sized spherical particles comprised of an oil core that is surrounded by a phospholipid monolayer with hydrophobic proteins embedded in the monolayer. The hydrophobic tails of the phospholipid monolayer are associated with the oily core of the oil body and the polar heads face outward. It is believed that the function of the hydrophobic proteins embedded in the phospholipid monolayer is to prevent fusion of multiple oil bodies. Plant seed material also includes protein bodies which are plant organelles that perform the function of storing proteins during seed germination to sustain growth. In addition to stored proteins, the protein bodies further include hydrolytic enzymes, lectins and inorganic ions. Plant seed material also include starch bodies or granules, which functions mainly as long-term and short-term carbon storage. When a plant seed, for example. commences growth the seed is starch degraded to provide carbon for the growth phase.

There remains a need to provide active component delivery systems, such as dry flavor delivery systems (both artificial and natural) with improved protection of the encapsulated flavor material, such as protection against oxidation and thermal processing. It is also desirable to encapsulate active components in a matrix made from foodstuffs, i.e. clean label products.

### SUMMARY

According to certain illustrative embodiments, disclosed is an active component delivery system comprising cryogenically comminuted plant material and the active component added the cryogenically comminuted plant material.

According to certain illustrative embodiments, disclosed is a flavor delivery system comprising cryogenically comminuted plant material and at least one flavor added to the cryogenically comminuted plant material.

According to certain illustrative embodiments, disclosed is a fragrance delivery system comprising cryogenically comminuted plant material and at least one fragrance added to the cryogenically comminuted plant material.

According to certain illustrative embodiments, disclosed is a method for making an active component delivery system, the method comprising cryogenically cooling the plant material, comminuting the plant material, and adding the active component to the cryogenically comminuted plant material.

According to certain illustrative embodiments, disclosed is a method for making a flavor delivery system, the method comprising cryogenically cooling the plant material, comminuting the plant material, and adding at least one flavor to the cryogenically comminuted plant material.

According to certain illustrative embodiments, disclosed is a method for making a fragrance delivery system, the method comprising cryogenically cooling the plant material, comminuting the plant material, and adding at least one fragrance to the cryogenically comminuted plant material.

According to certain illustrative embodiments, disclosed is a consumable composition comprising a consumable base and a flavor delivery system, wherein the consumable composition comprises cryogenically comminuted plant material and at least one flavor added to the cryogenically comminuted plant material.

According to certain illustrative embodiments, disclosed is a food product comprising a consumable food base and a flavor delivery system, wherein the food product comprises cryogenically comminuted plant material and at least one flavor added to the cryogenically comminuted plant material.

According to certain illustrative embodiments, disclosed is a beverage product comprising a consumable beverage base and a flavor delivery system, wherein the flavir delivery system comprises cryogenically comminuted plant material and at least one flavor added to the cryogenically comminuted plant material.

According to certain illustrative embodiments, disclosed is an oral care product comprising an oral care product base and a flavor delivery system, wherein the flavor delivery system comprises cryogenically comminuted plant material and at least one flavor added to the cryogenically comminuted plant material.

According to certain illustrative embodiments, disclosed is a personal care product comprising a personal care product base and a fragrance delivery system, wherein the flavor delivery system comprises cryogenically comminuted plant material and at least one fragrance added to the cryogenically comminuted plant material.

According to certain illustrative embodiments, disclosed is a method of making a food product comprising mixing together an ingestible food base with a plurality of active component delivery systems, wherein said active component delivery systems comprise cryogenically comminuted plant material and at least one active component added to the cryogenically comminuted plant material.

According to certain illustrative embodiments, disclosed is a method of making a food product comprising mixing together an ingestible food base with a plurality of flavor delivery systems, wherein the flavor delivery systems comprise cryogenically comminuted plant material and at least one flavor added to the cryogenically comminuted plant material.

According to certain illustrative embodiments, disclosed is a method of making a beverage product comprising mixing together an ingestible beverage base with a plurality of flavor delivery systems, wherein the flavor delivery systems comprise cryogenically comminuted plant material and at least one flavor added to the cryogenically comminuted plant material.

According to certain illustrative embodiments, disclosed is a method of making an oral care product comprising mixing together an oral care base with a plurality of active component delivery systems, wherein said active component delivery systems comprise cryogenically comminuted plant material and at least one active component added to the cryogenically comminuted plant material.

According to certain illustrative embodiments, disclosed is a method of making an oral care product comprising mixing together an oral care base with a plurality of flavor delivery systems, wherein said flavor delivery systems comprise cryogenically comminuted plant material and at least one flavor added to the cryogenically comminuted plant material.

According to certain illustrative embodiments, disclosed is a method of making a personal care product comprising mixing together a personal care product base with a plurality of active component delivery systems, wherein said active component delivery systems comprise cryogenically comminuted plant material and at least one active component added to the cryogenically comminuted plant material.

According to certain illustrative embodiments, disclosed is a method of making a personal care product comprising mixing together a personal care product base with a plurality of fragrance delivery systems, wherein said fragrance delivery systems comprise cryogenically comminuted plant material and at least one fragrance added to the cryogenically comminuted plant material.

According to certain illustrative embodiments, disclosed is a method of encapsulating, entrapping or loading an active component in at least one of protein bodies, oil bodies or starch bodies derived from plant material, the method comprises cryogenically cooling said plant material with a cryogen, comminuting said plant material, and adding said active component to said cryogenically cooled and comminuted plant material.

According to certain illustrative embodiments, disclosed is a method of encapsulating, entrapping or loading an active component in at least one of protein bodies, oil bodies or starch bodies derived from plant material, the method comprising adding said active component to cryogenically cooled and comminuted plant material.

According to certain illustrative embodiments, disclosed is an active component-containing delivery system comprising at least one of a protein body, oil body or starch body derived from cryogenically comminuted plant material and an active component encapsulated or entrapped within at least one of said protein body, oil body, or starch body.

According to certain illustrative embodiments, disclosed is a fragrance delivery system comprising at least one of a protein body, oil body, or starch body derived from cryogenically comminuted plant material and at least one fragrance component encapsulated or entrapped within at least one of said protein body, oil body or starch body.

According to certain illustrative embodiments, disclosed is a flavor delivery system comprising at least one of a protein body, oil body, or starch body derived from cryogenically comminuted plant material and at least one flavor encapsulated or entrapped within at least one of said protein body, oil body, or starch body.

According to certain illustrative embodiments, disclosed is a consummable comprising a consumable base and a plurality of flavor delivery systems, wherein each of said flavor delivery systems comprises at least one of a protein body, oil body, or starch body derived from cryogenically comminuted plant material and a flavor encapsulated or entrapped within at least one of said protein body, oil body or starch body.

According to certain illustrative embodiments, disclosed is a food product comprising an ingestible food base and a plurality of flavor delivery systems, wherein each of said flavor delivery systems comprises at least one of a protein body, oil body, or starch body derived from cryogenically comminuted plant material and a flavor encapsulated or entrapped within at least one of said protein body, oil body, or starch body.

According to certain illustrative embodiments, disclosed is a beverage product comprising an ingestible beverage base and a plurality of flavor delivery systems, wherein each of said flavor delivery systems comprises at least one of a protein body, oil body or starch body derived from cryogenically comminuted plant material and a flavor encapsulated or entrapped within at least one of said protein body, oil body, or starch body.

According to certain illustrative embodiments, disclosed is an oral care product comprising an oral care base and a plurality of flavor delivery systems, wherein each of said flavor delivery systems comprises at least one of a protein body, oil body, or starch body derived from cryogenically comminuted plant material and a flavor encapsulated or entrapped within at least one of said protein body, oil body, or starch body.

According to certain illustrative embodiments, disclosed is a personal care product comprising an personal care product base and a plurality of active component-containing delivery systems, wherein each of said active component-containing delivery systems comprises at least of a one protein body, oil body, or starch body derived from cryogenically comminuted plant material and an active component encapsulated or entrapped within at least one of said protein body, oil body, or starch body.

According to certain illustrative embodiments, disclosed is a personal care product comprising a personal care product base and a plurality of fragrance delivery systems, wherein each of said fragrance delivery systems comprises at least one of a protein body, oil body, or starch body derived from cryogenically comminuted plant material and a fragrance encapsulated or entrapped within at least one of said protein body, oil body, or starch body.

According to certain illustrative embodiments, disclosed is a method of making a food product comprising mixing together an ingestible food base with a plurality of flavor delivery systems, wherein each of said flavor delivery systems comprises at least one of a protein body, oil body, or starch body derived from cryogenically comminuted plant material with a flavor encapsulated or entrapped within at least one of said protein body, oil body, or starch body.

According to certain illustrative embodiments, disclosed is a method of making a beverage product comprising mixing together an ingestible beverage base with a plurality of flavor delivery systems, wherein each of said flavor delivery systems comprises at least one of a protein body, oil body, or starch body derived from cryogenically comminuted plant material with a flavor encapsulated or entrapped within at least one of said protein body, oil body, or starch body.

According to certain illustrative embodiments, disclosed is a method of making an oral care product comprising mixing together an oral care base with a plurality of active-component delivery systems, wherein each of said delivery systems comprise at least one of a protein body, oil body, or starch body derived from cryogenically comminuted plant material an oral care active component encapsulated or entrapped within at least one of said protein body, oil body or starch body.

According to certain illustrative embodiments, disclosed is a method of making a personal care product comprising, mixing together a personal care product base with a plurality of active-component delivery systems, wherein each of said delivery systems comprises at least one of a protein body, oil body, or starch body derived from cryogenically comminuted plant material a personal care active component encapsulated or entrapped within at least one of said protein body, oil body, or starch body.

### DETAILED DESCRIPTION

The following text sets forth a broad description of numerous different, illustrative embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

The present disclosure relates to active component delivery systems that are based on cryogenically treated or processed plant material, methods for making the active component delivery systems, compositions, formulations and products containing the active component delivery system, and methods for preparing compositions, formulations and products containing the active component delivery system. According to certain embodiments, the active-component delivery system is a flavor delivery system. According to other embodiments, the active-component delivery system is a fragrance delivery system.

The present disclosure is directed to the use of plant-derived bodies, granules, particles, or matrices for encapsulating, entrapping, or loading a desired type and amount of an active component. The plant-material may be used to encapsulate, entrap, or load active components, such as flavors and fragrances. The plant-material may be used to encapsulate, entrap, or load volatile active components, such as volatile flavors and fragrances. The encapsulation or entrapment of the active component within the plant-material protects the active component against evaporation and from oxidation during thermal processing.

The active component or components of the active-component delivery system may be carried by, encapsulated within, entrapped by or in, cryogenically cooled and comminuted plant material. The cryogenically cooled and comminuted plant material may include at least one of protein bodies, oil bodies, starch bodies, or other solid plant material. According to certain illustrative embodiments, the active component or components of the active-component delivery system is carried by, encapsulated by or within, entrapped by or within, at least one of protein bodies, oil bodies, starch bodies, or other solid plant material derived from cryogenically cooled and comminuted plant material.

The oleosomes useful in the present invention are micron-sized spherical intracellular plant organelles that are generally found in oleaginous (ie, oil-bearing) plant seeds. The oleosomes comprise an oily core that is surrounded by a phospholipid layer having proteins embedded in the phospholipid layer. According to certain embodiments, the oleosomes comprise an oily core that is surrounded by a phospholipid monolayer having hydrophobic proteins embedded in the phospholipid monolayer. According to certain illustrative embodiments, the oleosomes comprise an oil core containing about 94 weight percent to weight percent about 98% of a triglyceride that is surrounded by 0.6 weight percent to about 2 weight percent of a phospholipid monolayer, and from about 0.6 weight percent to about 4 weight percent of hydrophobic proteins embedded within the phospholipid monolayer surrounding the oil core of the oleosome.

Protein bodies derived from plant material, such as plant seeds, are plant organelles that perform the function of storing proteins during seed gemination to sustain growth. In addition to stored proteins, the protein bodies further include hydrolytic enzymes, lectins and inorganic ions.

The term “starch body” or “starch bodies” refer to storage bodies, granules, matrices and particles derived from plant material which function mainly as long-term and short-term carbon storage, and which are capable of carrying, encapsulating and/or entrapping a desired type and amount of an active component.

The delivery vehicle, such as the protein bodies, oil bodies, starch bodies, or other solid plant material may be obtained from any suitable plant seeds. By way of illustration, and not in limitation, suitable plant seeds from which the protein bodies, oil bodies, and/or starch bodies may be obtained include almond seeds, argan seeds, borage seeds, coconut, corn seeds, cotton seeds, chia seeds, flax seeds, grape seeds, hemp seeds, linseed, maize, mustard seeds, oil palm, pumpkin seeds, quinoa, rapeseeds, safflower seeds, sesame seeds, soybean, sunflower seeds, combinations thereof, and the like.

The active component-containing delivery systems may include from about 0.1% to about 10%, in another embodiment from about 1% to about 8%, in yet another embodiment about 3%, to about 6% or any individual number within the range, by weight of the active component-containing delivery system of at least one active component.

The active component-containing delivery systems may include from about 90% to about 99.9%, in another embodiment from about 92% to about 99%, in yet another embodiment about 94%, to about 97% or any individual number within the range, by weight of the active component-containing delivery system of the cryogenically treated plant material.

A method for making an active component-containing delivery system is further disclosed. The method includes loading at least one of protein bodies, oil bodies, starch bodies and other solid material derived from a suitable plant material, such as plant seeds, with an active component. According to certain embodiments, the method of making the active component-containing delivery comprises cryogenically cooling plant seeds, comminuting the plant seeds and adding at least one active component to the cryogenically cooled and comminuted plant seed material to load, encapsulate, or entrap at least one active component, such as at least one flavor or at least one fragrance, within the plant seed material. According to certain embodiments, the cryogenically cooled and comminuted plant material is allowed to return to approximately room temperature before the at least one active component is added to the comminuted plant material. The cryogenically cooled and comminuted plant seed material may include the protein bodies, oil bodies, starch bodies, and other solid seed material including biopolymers, fibers, hulls and shells. According to certain other embodiments, the method may include cryogenically cooling and comminuting the plant seeds, removing or otherwise isolating or separating at least one of the protein bodies, oil bodies, or starch bodies from the other plant seed material (ie. biopolymers, fibers, hulls, shells, etc), and loading the at least one of the protein bodies, oil bodies, or starch bodies with the desired amount of the active component, such as a flavor or fragrance.

According to certain embodiments, the methods involve cryogenically cooling or chilling the plant material, such as plant seeds, and mechanically reducing the size of the plant seeds to smaller particle sizes. The act of cryogenically cooling or chilling the plant seeds embrittles the seeds for mechanical reduction of particle size. The process of cryogenically cooling or chilling a feed material, such as plant seeds, and reducing the particle size of the plant seeds, may be referred to as cryogenic grinding, cryogenic milling, cryomilling, freezer grinding or freezer milling.

Cryogenic fluids are those cooling or chilling fluids that are liquids at or below a temperature of about -150° C. Suitable cryogenic fluids for use in cryogenically cooling or chilling the plant seeds include, for example, liquid argon, liquid carbon dioxide, liquid helium, liquid nitrogen, and the like. According to certain embodiments, the cryogenic fluid used to cryogenically cool the plant seeds is liquid nitrogen. According to certain embodiments, the cryogenic fluid used to cryogenically cool the plant seeds is liquid helium. The cryogenic cooling or chilling of the plant seeds with the cryogenic fluid can be carried out at any cryogenic temperatures that are suitable to sufficiently embrittle the oil-bearing plant seeds for mechanical particle size reduction to provide a delivery vehicle for an active component. By way of illustration, the cryogenic cooling or chilling of the plant seeds with the cryogenic fluid can be carried out at temperatures at or below −150° C., at or below −160° C., at or below −170° C., at or below −180° C., at or below −190° C. or at or below −200° C. Solid cryogen, such as dry ice, may be used to cryogenically cool or chill the plant material in accordance with the methods disclosed herein.

The method of mechanically comminuting or reducing the size of the cryogenically cooled or chilled plant seeds comprises mechanically breaking apart, cracking, crushing, cutting, dividing, extruding, fracturing, grating, grinding, milling or splitting the plant seeds into smaller particles, pieces, or powders. By way of example, and without limitation, cryogenic grinding or milling of the plant seed material may be carried out in an impact mill such as a ball cryomill, centrifuge cryomill, a knife cryomill, and like cryomills.

A cryogenic ball mill may be used to cryogenically grind or mill the plant material, such as plant seeds. According to the cryogenic ball milling process, the milling ball or balls are placed within the grinding vessel with the plant seeds to be cryogenically ground or milled. The grinding vessel is sealed and engaged within a chamber of the cryomill. The liquid cryogen, such as liquid nitrogen, is fed into the cryomill to pre-cool the grinding vessel and the plant seed material contained within the grinding vessel. Once the plant seeds have been sufficiently pre-chilled or pre-cooled with the liquid cryogen, then the grinding vessel is agitated, rotated, or shaken while under continuous cryogenic cooling by the liquid cryogen at a temperature and for a time sufficient to reduce the particle size of the plant seeds to smaller particles, pieces, or a powder like material.

A cryogenic knife mill may be used to cryogenically grind or mill the plant material, such as plant seeds. According to the cryogenic knife milling process, the plant seeds to be cryogenically ground or milled are blended with a liquid cryogen or a solid cryogen (eg. dry ice) in a grinding chamber. The grinding chamber includes rotating blades or knives for mechanically reducing the particle size of the plant seeds. The grinding vessel is sealed and blades or knives are rotated within the grinding vessel while the plant seeds are cryogenically cooled by the cryogen. The process is carried out at a temperature and for a time sufficient to reduce the particle size of the plant seeds to smaller particles, pieces, or a powder like material.

A cryogenic centrifuge mill may be used to cryogenically grind or mill the plant material, such as plant seeds. According to the cryogenic centrifugal milling process, the plant seeds to be cryogenically ground or milled are combined with a liquid cryogen to cool or chill the plant seeds. The milling chamber is fitted with a rotating disc and collection pan having an outlet to be connected to a cyclone. A toothed rotor is positioned within the collection pan and engaged with a rotatable shalt. A cylindrical screen sieve is positioned about the immediate outer periphery of the toothed rotor. A lid is placed over the collection pan, and the outlet of the collection pan is attached to the cyclone. The milling chamber is closed. The plant seeds that have been cryogenically cooled are fed into the grinding chamber of the cryomill. During the centrifugal milling process, centrifugal acceleration throws the cryogenically cooled plant seeds outwardly with high energy and it is crushed on impact with the rotor teeth of the toothed rotor moving at a high speed. The crushed plant seeds are then further ground between the rotor and the ring screen sieve.

According to certain illustrative embodiments, the method includes loading cryogenically cooled and comminuted plant material, such as plant seeds, with a flavor to prepare a flavor delivery system. The method for making a flavor system may comprise accessing or obtaining at least one of protein bodies, oil bodies, or starch bodies by cryogenically cooling and comminuting plant seeds and encapsulating at least one flavor component within at least one of the protein bodies, oil bodies, or starch bodies.

According to certain illustrative embodiments, the method includes loading cryogenically cooled and comminuted plant material, such as plant seeds, with a fragrance to prepare a fragrance delivery system. The method for making a fragrance system may comprise accessing or obtaining at least one of protein bodies, oil bodies, or starch bodies by cryogenically cooling and comminuting plant seeds, and encapsulating at least one fragrance component within at least one of the protein bodies, oil bodies, or starch bodies

As used throughout the present specification, the terms “flavor or fragrance” encompass flavor or fragrance ingredients or compositions of current use in the flavor and/or fragrance industry, of both natural and synthetic origin. It includes single compounds and mixtures. Specific examples of such flavor or fragrance ingredients may be found in the current literature, e.g. in Fenaroli's Handbook of flavour ingredients, 1975, CRC Press; Synthetic Food adjuncts, 1947 by M. B. Jacobs, edited by Van Nostrand; or Perfume and Flavor Chemicals by S. Arctander, 1969, Montclair, N.J. (USA). The flavoring or perfuming ingredients may be present in the form of a mixture with solvents, adjuvants, additives and/or other components, generally those of current use in the flavors and fragrance industry.

Flavor and fragrance compositions may include a broad variety of mixtures of aromatic and fragrant ingredients, such as terpenes, terpene derivatives, esters, alcohols, ethers, ketones, lactones, aldehydes, anthranilates, nitriles, mercaptans, N- and S-heterocycles and the like.

Examples of suitable flavor ingredients include, but are not limited to, natural flavors, artificial flavors, spices, seasonings, synthetic flavor oils and flavoring aromatics and/or oils, oleoresins, essences, and distillates, and a combination comprising at least one of the foregoing.

Flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yuzu, sudachi, and fruit essences including apple, pear, peach, grape, raspberry, blackberry, gooseberry, blueberry, strawberry, cherry, plum, prune, raisin, cola, guarana, neroli, pineapple, apricot, banana, melon, apricot, cherry, tropical fruit, mango, mangosteen, pomegranate, papaya, and so forth.

Additional exemplary flavors imparted by a flavorant include a milk flavor, a butter flavor, a cheese flavor, a cream flavor, and a yogurt flavor, a vanilla flavor, tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a chamomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor. and a walnut flavor; floral flavors; and vegetable flavors, such as an onion flavor, a garlic flavor, a cabbage flavor, a carrot flavor, a celery flavor, mushroom flavor, and a tomato flavor.

According to some embodiments, flavorants may also include aldehydes and esters such as cinnamyl acetate ((E)-3-phenylprop-2-en-1-yl acetate); cinnamaldehyde ((2E)-3-phenylprop-2-enal); citral diethylacetal ((E)-1,1-dimethoxy-3,7-dimethylocta-2,6-diene), dihydrocarvyl acetate (2-methyl-5-prop-1-en-2-ylcyclohexyl acetate), eugenyl formate ((2S)-1,3,3-trimethylbicyclo[2.2.1]heptan-2-yl acetate), p-methylanisol (1-methoxy-4-methybenzene), and so forth can be used. Further examples of aldehyde flavourings include acetaldehyde (apple), benzaldehyde (cherry, almond), anisic aldehyde (4-methoxybenzaldehyde) (licorice, anise), cinnamic aldehyde ((2E)-3-phenylprop-2-enal) (cinnamon), citral (E)-3,7-dimethylocta-2,6-dienal), i.e., alpha-citral ((EE)-3,7-dimethylocta-2,6-dienal (lemon, lime), neral, i.e., beta-citral ((EZ)-3,7-dimethylocta-2,6-dienal (lemon, lime), decanal (orange, lemon), ethyl vanillin (vanilla, cream), heliotrope, i e., piperonal (benzo[d][1,3]dioxole-5-carbaldehyde) (vanilla, cream), vanillin (vanilla, cream), alpha-amyl cinnamaldehyde ((E or Z)-2-benzy lideneheptanal) (spicy fruity flavours), butyraldehyde (butanal) (butter, cheese), valeraldehyde (pentanal) (butter, cheese), citronellal (3,7-dimethyloct-6-enal) (modifies, many types), decanal (citrus fruits), aldehyde C-8 (octanal) (citrus fruits), aldehyde C-9 (nonanal) (citrus fruits), aldehyde C-12 (dodecanal) (citrus fruits), 2-ethyl butyraldehyde (2-ethyl.butanal) (berry fruits), hexenal, i.e., trans-2 hexenal (berry fruits), tolyl aldehyde (4-methylbenzaldehyde) (cherry, almond), veratraldehyde (3,4-dimethoxybenzaldehyde) (vanilla), 2,6-dimethyl-5-heptenal, i.e., melonal (melon), 2,6-dimethyloctanal (green fruit), and 2-dodecenal (citrus, mandarin), and the like.

Examples of suitable fragrance ingredients include, but are not limited to hex-3-en-1-yl butyrate; 2-methyl-1-phenylpropan-2-yl acetate; 2-methyl-1-phenylpropan-2-yl butyrate; 4-(tert-butyl)cyclohexyl acetate, undecan-2-one; 2-benzylideneoctanal; 3,7-dimethylnona-1,6-dien-3-yl acetate; 3,7-dimethylocta-2,6-dien-1-yl acetate; 3,7-dimethylocta-2,6-dienal; non-6-enal; tridec-2-enenitrile; 1-((1,8a)-1,4,4,6-tetramethyl-2,3,3a,4,5,8-hexahydro-1-5,8a-methanoazulen-7-yl)ethanone; 1-(2,3,8,8-tetramethyl-1,2,3,4,5,6,7,8-octahydronaphthalen-2-yl)ethanone; 1-butoxy-1-oxopropan-2-yl butyrate; 2-methyl-1-phenylpropan-2-ol; allyl 2-(isopentyloxy)acetate; allyl 3-cyclohexylpropanoate; methyl non-2-ynoate; undec-9-enal; 1,3,4,5,6,7-hexahydro-.beta.,1,1,5,5-pentamethyl-2-2,4a-ethanonaphthalene-8-ethanol; 1-(1-ethoxyethoxy)hex-3-ene. 1-(2,6,6-trimethylcyclohex-3-en-1-yl)but-2-en-1-one; 1-(2,6,6-trimethylcyclohexa-1,3-dien-1-yl)but-2-en-1-one; 1,1-diethoxy-3,7-dimethylocta-2,6-diene; 2-ethyl-4-(2,2,3-trimethylcyclopent-3-en-1-yl)but-2-en-1-ol; 3,7-dimethylnona-1,6-dien-3-ol; 3,7-dimethylocta-2,6-dien-1-yl isobutyrate; 3-methyl-2-(pent-2-en-1-yl)cyclopent-2-enone; 4-(2,5,6,6-tetramethylcyclohex-2-en-1-yl)but-3-en-2-one; 4(2,6,6-trimethylcyclohex-1-en-1-yl)but-3-en-2-one; 4-(2,6,6-trimethylcyclohex-2-en-1-yl)but-3-en-2-one; 1,3,3-trimethylbicyclo[2.2.1]heptan-2-yl acetate; (2,4)-1,7,7-trimethylbicyclo[2.2.1]heptan-2-yl acetate; (ethoxymethoxy)cyclododecane; 1-(2,6,6-trimethylcyclohexa-1,3-dien-1-yl)but-2-en-1-one; 3,4,5,6,6-pentamethylhept-3-en-2-one; 3,7,11-trimethyldodeca-1,6,10-trien-3-yl acetate; 3,7-dimethylocta-2,6-dien-1-ol 3,7-dimethylocta-2,6-dienal; 3-methyl-5-(2,2,3-trimethylcyclopent-3-en-1-yl)pent-4-en-2-ol; 3-methylcyclotetradec-5-enone; 4-((3a,7a)-hexahydro-1-4,7-methanoinden-5(6)-ylidene)butanal; 4-(2,6,6-trimethylcyclohex-2-en-1-yl)but-3-en-2-one; 4,11,11-trimethyl-8-methylenebicyclo[7.2.0]undec-4-ene; 4-methyldec-3-en-5-ol; 5-methylheptan-3-one oxime; methyl non-2-enoate; oxacyclohexadec-12-en-2-one; 1-((2-(tert-butyl)cyclohexyl)oxy)butan-2-ol; 1-(3,3-dimethylcyclohex-1-en-1-yl)pent-4-en-1-one; 1,2,4)-1,3,3-trimethylbicyclo[2.2.1]heptan-2-ol; 1,2,4)-2′-isopropyl-1,7,7-trimethylspiro[bicyclo[2.2.1]heptane-2,4′-[1,3]dioxane]; 1,2,5)-2-ethoxy-2,6,6-trimethyl-9-methylenebicyclo[3.3.1]nonane; 112) (4-(4-hydroxyphenyl)butan-2-one; 1-methyl-2-(5-methylhex-4-en-2-yl)cyclopropyl)-methanol; 1-methyl-4-(4-methylpent-3-en-1-yl)cyclohex-3-enecarbaldehyde; 1-methyl-4-propan-2-ylcyclohexa-1,4-diene; (1s,4s)-1,3,3-trimethyl-2-oxabicyclo[2.2.2]octane; 2-(4-methylcyclohex-3-en-1-yl)propan-2-yl acetate; 2)-ethyl 3-isopropylbicyclo[2.2.1]hept-5-ene-2-carboxylate; 2,2-dimethoxyethyl)benzene; 2,6)-3,7-dimethylnona-2,6-dienenitrile: 2,6-dimethyloctan-2-ol; 2-isopropyl-5-methylcyclohexanol; 2-methyl-4-oxo-4-pyran-3-yl isobutyrate; 2-methyl-6-methyleneoct-7-en-2-yl acetate; 3-(4-isopropylphenyl)-2-methylpropanal; 3,5,5-trimethylhexyl acetate; 3,5-dimethylhex-3-en-2-yl)oxy)-2-methylpropyl cyclopropanecarboxylate; 3,7-dimethyloct-6-en-1-yl acetate; 3,7-dimethyloct-6-en-1-yl formate: 3,7-dimethyloct-6-en-1-yl propionate; 3,7-dimethyloct-6-enenitrile; 3,7-dimethylocta-1,6-dien-3-yl acetate; (3a,4,7,7a)-ethyl octahydro-1-4,7-methanoindene-3a-carboxylate; (3a,6,7a)-3a,4,5,6,7,7a-hexahydro-1-4,7-methanoinden-6-yl acetate; (3a,6,7a)-3a,4,5,6,7,7a-hexahydro-1-4,7-methanoinden-6-yl isobutyrate, (3a,6,7a)-3a,4,5,6,7,7a-hexahydro-1-4,7-methanoinden-6-yl propionate; (3-methyl-2-pentylcyclopent-2-enone; 4,7-dimethyloct-6-en-3-one; 4-methylene-2-phenyltetrahydro-2-pyran; 6,6-dimethoxy-2,5,5-trimethylhex-2-ene; allyl heptanoate; cyclohexyl 2-hydroxybenzoate; ethyl 2,6,6-trimethylcyclohexa-1,3-diene-1-carboxylate; ethyl heptanoate; ethyl hexanoate; hexyl isobutyrate; pentyl 2-hydroxybenzoate; propanedioic acid 1-(1-(3,3-dimethylcyclohexyl)ethyl) 3-ethyl ester; 3-methyl-4-(2,6,6-trimethylcyclohex-2-en-1 -yl)but-3-en-2-one; dimethylcyclohexyl)ethyl formate; 1-(3,5,5,6,8,8-hexamethyl-5,6,7,8-tetrahydronaphthalen-2-yl)ethanone; 1-(spiro[4.5]dec-6-en-7-yl)pent-4-en-1-one; 1,1,2,3,3-pentamethyl-2,3,6,7-tetrahydro-1-inden-4(5)-one; decanal; 2-methyldecanal: undec-10-enal; undecanal; 2-methylundecanal; 1-methyl-4-(prop-1-en-2-yl)cyclohex-1-ene; 1-methyl-4-(prop-1-en-2-yl)cyclohex-1-ene; 1-methyl-4-(propan-2-ylidene)cyclohex-1-ene; 2- (isopropyl 2-methyl butanoate; 2-(1-(3,3-dimethylcyclohexyl)ethoxy)-2-methylpropyl cyclopropanecarboxylate; 2-(2-(4-methylcyclohex-3-en-1-yl)propyl)cyclopentanone; 2-(2,4-dimethylcyclohexyl)pyridine; 2-(sec-butyl)cyclohexanone; 2-(tert-butyl)cyclohexyl acetate; 2,2,2-trichloro-1-pheny lethyl acetate; 2,2,5-trimethyl-5-pentylcyclopentanone; 2,2-dimethyl-2-pheylethyl propanoate; 2,4,6-trimethyl-4-phenyl-1,3-dioxane; 2,4,6-trimethylcyclohex-3-enecarbaldehyde; 2,6,10-trimethylundec-9-enal; 2,6-dimethylhept-5-enal; 2,6-dimethylheptan-2-ol; 2-cyclohexylidene-2-(o-tolyl)acetonitrile; 2-cyclohexylidene-2-phenylacetonitrile; 2-ethyl-methyl-(m-tolyl)butanamide; 2-isopropyl-5-methylcyclohexanone; 2-methyl-4-methylene-6-phenyltetrahydro-2-pyran; 2-methyldecanenitrile; 2-pentylcyclopentanone; 3-(3-isopropyl phenyl)butanal; 3-(4-(tert-butyl)phenyl)-2-methylpropanal; 3-(4-ethylphenyl)-2,2-dimethylpropanal; 3-(4-isobutyl-2-methylphenyl)propanal; 3-(4-isobutylphenyl)-2-methylpropanal; 3,7-dimethyloct-6-en-1-ol; 3,7-dimethyloct-6-enal; 3,7-dimethylocta-1,6-dien-3-ol; 3,7-dimethyloctan-3-ol; 4-(4-methylpent-3-en-1-yl)cyclohex-3-enecarbaldehyde, 4-(tert-pentyl)cyclohexanone; 4,4a,5,9b-tetrahydroindeno[1,2-d][1,3]dioxine; 4-cyclohexyl-2-methylbutan-2-ol; 5-(sec-butyl)-2-(2,4-dimethylcyclohex-3-en-1-yl)-5-methyl-1,3-dioxane; 5-tent-butyl-2-methyl-5-propyl-2-furan; 6-(sec-butyl)quinoline; 6,8-dimethylnonan-2-ol; 6-ethyl-3-methyloct-6-en-1-ol; 8-(sec-butyl)-5,6,7,8-tetrahydroquinoline; 8,8-dimethyl-1,2,3,4,5,6,7,8-octahydronaphthalene-2-carbaldehyde; allyl 2-(cyclohexyloxy)acetate: dec-4-enal; dec-9-en-1-ol; dodec-2-enal; dodecanal; dodecanenitrile; ethyl 2-ethyl-6,6-dimethylcyclohex-2-enecarboxylate; ethyl 2-methylpentanoate; ethyl octanoate; hex-3-en-1-yl methyl carbonate; hexyl 2-hydroxy benzoate; methyl 3-oxo-2-pentylcyclopentaneacetate; oxacyclohexadecan-2-one; and the like.

According to certain embodiments, the food product is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and all of which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

According to certain embodiments, the plurality of the flavor delivery systems are dispersed throughout a plant-based or vegetarian food base to create a plant-based food product containing the flavor capsules.

According to certain embodiments, the food product is a vegetarian food product. In other embodiments, the food product is a vegan food product containing only plant-derived components and no animal-derived components.

Consumable products, including, but not limited to all food products, food additives, nutraceuticals, pharmaceuticals and any product placed in the mouth including chewing gum, oral care products, and oral hygiene products including but not limited to, cereal products, rice products, tapioca products, sago products, baker's products, biscuit products, pastry products, bread products, confectionery products, dessert products, gums, chewing gums, mouthwash, dental floss, flavored or flavor-coated straws, flavor or flavor-coated food/beverage containers, chocolates, ices, honey products, treacle products, yeast products, baking-powder, salt and spice products, savory products, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, medicaments, beverages, carbonated beverages, alcoholic drinks such as beers, wines and spirits, non-alcoholic drinks such as soft drinks, mineral and aerated waters, fruit drinks, fruit juices, coffee, artificial coffee, tea, cocoa, including forms requiring reconstitution including, without limitation, beverage powder, milk based beverage powder, sugar-free beverage powder, beverage syrup, beverage concentrate, instant coffee, instant tea, instant cocoa, and coffee whitener. Food extracts, plant extracts, meat extracts, condiments, gelatins, pharmaceutical and non-pharmaceutical gums, tablets, lozenges, drops, emulsions, elixirs, syrups and other preparations for making beverages, and combinations thereof.

According to certain illustrative embodiments, the cryogenically cooled and comminuted plant seed material can be used to prepare an edible or ingestible food product. The food product comprises an edible or ingestible food base component or material and a plurality of flavor delivery systems dispersed, distributed, or otherwise incorporated into the food base component or material. The flavor delivery systems comprise at least one of a protein body, oil body, or starch body with a flavor at least partially encapsulated or entrapped within the at least one of the protein bodies, oil bodies, or starch bodies. The method of making a food product comprises mixing together an edible or ingestible food base component or material with a plurality of the flavor systems. According to certain embodiments, the food product comprises from about 95 to about 99.9 weight percent of the food base component or material from about 0.1 to about 5 weight percent of the flavor delivery systems, based on the total weight of the food product. According to other embodiments, the food product comprises from about 97 to about 99.5 weight percent of the food base component or material from about 0.5 to about 3 weight percent of the flavor delivery systems, based on the total weight of the food product. According to other embodiments, the food product comprises from about 98 to about 99 weight percent of the food base component or material from about I to about 2 weight percent of the flavor delivery systems, based on the total weight of the food product.

According to certain illustrative embodiments, the cryogenically cooled and comminuted plant seed material can be used to prepare a drinkable or ingestible beverage product. The beverage product may be a liquid beverage product or a dry beverage product that must be reconstituted with water prior to drinking. The beverage product comprises an edible or ingestible beverage base component or material and a plurality of flavor delivery systems dispersed, distributed, or otherwise incorporated into the beverage base component or material. The flavor systems comprise at least one of a protein body, an oil body, and/or a starch body with a flavor at least partially encapsulated or entrapped within at least one of the protein bodies, oil bodies, or starch bodies. The method of making a beverage product comprises mixing together a drinkable or ingestible beverage base component or material with a plurality of the flavor systems. According to certain embodiments the beverage product comprises from about 95 to about 99.9 weight percent of the beverage base component or material from about 0.1 to about 5 weight percent of the flavor delivery systems, based on the total weight of the beverage product. According to other embodiments, the beverage product comprises from about 97 to about 99.5 weight percent of the beverage base component or material from about 0.5 to about 3 weight percent of the flavor delivery systems, based on the total weight of the beverage product. According to other embodiments, the beverage product comprises from about 98 to about 99 weight percent of the beverage base component or material from about 1 to about 2 weight percent of the flavor delivery systems, based on the total weight of the beverage product.

According to certain illustrative embodiments, the cryogenically cooled an comminuted plant seed material can be used to prepare an oral care product. The oral care product comprises an oral care base component or material and a plurality of flavor delivery systems dispersed, distributed, or otherwise incorporated into the oral care base component or material. The flavor systems comprise at least one of a protein body, oil body, or starch body with a flavor at least partially encapsulated or entrapped within the body. The method of making an oral care product comprises mixing together an oral care base component or material with a plurality of the flavor systems. According to certain embodiments the oral care product comprises from about 95 to about 99.9 weight percent of the oral care base component or material from about 0.1 to about 5 weight percent of the flavor delivery systems, based on the total weight of the oral care product. According to other embodiments, the oral care product comprises from about 97 to about 99.5 weight percent of the oral care base component or material from about 0.5 to about 3 weight percent of the flavor delivery systems, based on the total weight of the oral care product. According to other embodiments, the oral care product comprises from about 98 to about 99 weight percent of the oral care base component or material from about 1 to about 2 weight percent of the flavor delivery systems, based on the total weight of the oral care product.

Oral care products, as hereinabove mentioned, include any composition applied to the oral cavity for the purposes of cleaning, freshening, healing, deodorizing the cavity or any part thereof, may include, but are not limited to, toothpastes, tooth gels, tooth powders, tooth whitening products, mouthwashes, lozenges, dental floss, toothpicks, anti-plaque and anti-gingivitis compositions, throat lozenges, throat drops, inflammatory compositions, compositions for treatment of nasal symptoms, cold symptoms and upper gastrointestinal tract distress, compositions for cold relief, for alleviating discomfort of hot flash, and gargle compositions.

Cosmetic products, such as aftershave lotions, baby products, including lotions, oils, powders, creams and shampoos, basecoats and undercoats, bath preparations, including capsules, oils, tablets, salts, soaps and detergents, beard softeners, blushers, body and hand preparations, bubble baths, cleaning products, colognes and toilet waters, cuticle softeners, dentifrices, deodorants, depilatories, douches, eye lotions, eye makeup preparations including eye makeup removers, eye shadows, eyebrow pencils and eyeliners, face and neck preparations, face powders, feminine hygiene deodorants, foot powders and sprays, foundations, fragrance preparations, hair and scalp preparations including bleaches, colour sprays and other colouring preparations such as dyes and colours, hair tighteners with colour, hair conditioners, hair preparations, hair rinses, hair shampoos, hair sprays, hair straighteners, hair tints, hair tonics, hair wave sets, indoor tanning preparations, leg and body paints, lipsticks, makeup bases, makeup preparations including fixatives, manicuring preparations, mascara, men's talcum, moisturizing preparations, nail creams and lotions, nail extenders, nail polish and enamel removers, nail polish and enamels, night skin care preparations, paste masks, perfumes, permanent waves, personal cleanliness products, powders, preshave lotions, rouges, sachets, shampoos, shaving cream, shaving preparations miscellaneous, shaving soap, skin care preparations, including fresheners, suntan preparations including gels, creams and liquids.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

The compositional weight percentages disclosed herein are based on the total weight of the flavor capsules or the food product, as the situation dictates. It will be understood to one of ordinary skill in the art that the total weight percent of the flavor capsules or food product cannot exceed 100%. For example, a person of ordinary skill in the art would easily recognize and understand that a flavor capsule comprising 50 to 95 weight percent of a plant-derived oil bodies, 5 to 50 weight percent flavor, and 1 to 10 weight percent further additives will not exceed 100%. A person of ordinary skill in the art would understand that the amount of the components may be adjusted to include the desired amount of component without exceeding 100% by weight of the flavor capsule or food product.

### EXAMPLES

The disclosure is further described with reference to the following non-limiting examples. The following examples are given solely for the purpose of illustration and are not to be construed as limitations of the present invention, as many variations of the invention are possible without departing from the spirit and scope of the present disclosure.

### Example 1—Cryogenic Grinding of Rapeseeds

30 grams of Dwarf Essex Rapeseeds were introduced into a sample container with a steel impactor rod. The sample container was sealed and placed in a chamber of a SPEX 6850 freezer mill filled with t liquid nitrogen at a temperature of about −200° C. The rapeseed samples were cryogenically agitated for two five-minute cycles to grind the rapeseeds. The sample container was removed from the chamber of the freezer mill, the ground rapeseeds were transferred to a sample container, and the sample jar was sealed to prevent moisture adsorption.

### Example 2—Loading Strawberry Flavor into Cryogenically-Ground Plant Seeds

Cryogenically-ground plant seed powder was loaded with strawberry flavor. 90 grams of cryogenically-ground plant seed powder was placed into the bowl of a planetary mixer equipped with a paddle blade. 5 grams of water was slowly added to the bowl with mixing at low speed of about 60 RPM to create a mixture. The mixture was mixed at moderate speed of about 120 RPM for 5 minutes to uniformly distribute the water. 5 grams of flavor was added to the bowl of the mixer and the mixture was mixed at low speed for 5 minutes to uniformly distribute the flavor. The material was removed from the bowl of the mixer and placed into a sample container.

### Example 3—Loading Toasted Bread Flavor into Cryogenically-Ground Rapeseeds

970 g of cryogenically-ground rapeseeds was added to the bowl of a planetary mixer equipped with a paddle blade. While mixing at low speed, 10 g of canola oil was added, followed by further mixing for 5 minutes. While continued mixing at low speed, 20 g of toasted bread flavor was added and mixed for 5 minutes. Mixing was stopped, the mixed material was removed from the bowl and placed in an appropriate container. The container was closed and allowed to sit for 24 hours before use.

### Example 4—Sweet Crackers made with Toasted Bread Flavor-loaded, Cryogenically-Ground Rapeseed

Sweet crackers were made with 1% (wt/wt) of the 2.0% flavor-loaded cryogenically-ground rapeseeds from Example 3.

Comparative Example 5 - Sweet Crackers made with Toasted Bread Liquid Flavor

Sweet crackers were also made with 0.2% of a liquid version of the same flavor (1 part of flavor mixed with 9 parts of canola oil).

The sweet crackers of Example 4 and Comparative Example 5 were prepared using the following sweet cracker recipe:

| Ingredients | % by weight | % by weight |
|---|---|---|
| Sugar | 18.33 | 18.33 |
| Vegetable Shortening | 21.90 | 21.90 |
| Non Fat Dried Milk | 0.65 | 0.65 |
| Egg | 3.67 | 3.67 |
| Water | 5.75 | 5.75 |
| Flour | 47.82 | 48.62 |
| Baking Soda | 0.43 | 0.43 |
| Flavor-loaded cryoground rapeseeds | 1.00 | |
| Liquid flavor | | 0.2 |
| Salt | 0.45 | 0.45 |
| Total | 100.00 | 100.00 |

The sweet crackers of Example 4 and Comparative Example 5 were baked at 200° C. for ten minutes. The sweet crackers were tasted by experienced tasters. The tasters were requested to rank each sample on flavor intensity. The sweet cracker made with the flavor-loaded, cryogenically-ground rapeseed exhibited a much more authentic flavor profile, and retained more of the flavor's volatile components as compared to the sweet cracker made with the liquid flavor.

### Example 6—Loading Strawberry Flavor into Cryogenically-Ground Rapeseeds

970g of cryogenically-ground rapeseeds was added to the bowl of a planetary mixer equipped with a paddle blade. While mixing at low speed, 5 g of canola oil was added, followed by further mixing for 5 minutes. While continued mixing at low speed, 25 g of strawberry flavor was added, and mixed for 5 minutes. Mixing was stopped, the mixed material was removed from the bowl and placed in an appropriate container. The container was closed and allowed to sit for 24 hours before use.

### Example 7—Loading Strawberry Flavor into Cryogenically-ground quinoa

970 g of cryogenically-ground quinoa was added to a ribbon blender or beaker. While mixing at low speed, 5 g of canola oil was added, followed by further mixing for 5 minutes. While continued mixing at low speed, 25 g of strawberry flavor was added, and mixed for 5 minutes. Mixing was stopped, the mixed material was removed from the bowl and placed in an appropriate container. The container was closed and allowed to sit for 24 hours before use.

### Example 8—Sweet Crackers made with Strawberry Flavor-Loaded, Cryogenically-Ground Rapeseeds

Sweet crackers were made with 1% (wt/wt) of the 2.5% flavor-loaded cryogenically-ground rapeseeds from Example 6.

### Example 9—Sweet Crackers made with Strawberry Flavor-loaded Cryogenically-Ground Quinoa

Sweet crackers were made with 1% (wt/wt) of the 2.5% flavor-loaded cryogenically-ground quinoa from Example 7.

### Comparative Example 10—Sweet Crackers made with Strawberry Liquid Flavor

Sweet crackers were also made with 0.1% of a liquid version of the same flavor (25 parts of flavor mixed with 75 parts of canola oil).

The sweet crackers of Examples 8 and 9, and Comparative Example 10 were prepared using the following sweet cracker recipe:

| Ingredients | % by weight | % by weight |
|---|---|---|
| Sugar | 18.33 | 18.33 |
| Vege table Shortening | 21.90 | 21.90 |
| Non Fat Dried Milk | 0.65 | 0.65 |
| Egg | 3.67 | 3.67 |
| Water | 5.75 | 5.75 |
| Flour | 47.82 | 48.72 |
| Baking Soda | 0.43 | 0.43 |
| Flavor-loaded cryoground rapeseeds | 1.00 | |
| Liquid flavor | | 0.1 |
| Salt | 0.45 | 0.45 |
| Total | 100.00 | 100.00 |

The sweet crackers of Examples 8 and 9 and Comparative Example 10 were baked at 200° C. for ten minutes. The sweet crackers were tasted by experienced tasters. The tasters were requested to rank each sample on flavor intensity. The sweet crackers made with the flavor-loaded, cryogenically-ground rapeseed and quinoa (Examples 8 and 9) exhibited a much more authentic flavor profile, and retained more of the flavor' s volatile components as compared to the sweet cracker made with the liquid flavor (Comparative Example 10).

### Example 11—Loading Herb de Provence Flavor into Cryogenically-Ground Rapeseeds

980 g of cryogenically-ground rapeseed were added to the bowl of a planetary mixer equipped with a paddle blade. While mixing at low speed, 5 g of canola oil was added, followed by further mixing for 5 minutes. While continued mixing at low speed, 10 g of herb de provence flavor was added, and mixed for 5 minutes. While continued mixing, 5 g of paprika oleoresin was added, and mixed for 5 minutes. Mixing was stopped, the mixed material was removed from the bowl and placed in an appropriate container. The container was closed and allowed to sit for 24 hours before use.

### Example 12—Sweet Crackers made with Herb de Provence Flavor-loaded, Cryogenically-Ground Rapeseeds

Sweet crackers were made with 1% (wt/wt) of the 1.5% flavor-loaded cryogenically-ground rapeseeds from Example 11.

Comparative Example 13—Sweet Crackers made with Herb de Provence Liquid Flavor

Sweet crackers were also made with 0.2% of a liquid version of the same flavor (25 parts of paprika oleoresin, 50 parts of herb de provence flavor, and 925 parts of medium chain triglycerides).

The sweet crackers of Example 12 and Comparative Example 13 were prepared using the following sweet cracker recipe:

| Ingredients | % by weight | % by weight |
|---|---|---|
| Sugar | 18.33 | 18.33 |
| Shortening | 21.90 | 21.90 |
| Non Fat Dried Milk | 0.65 | 0.65 |
| Egg | 3.67 | 3.67 |
| Water | 5.75 | 5.75 |
| Flour | 47.82 | 48.62 |
| Baking Soda | 0.43 | 0.43 |
| Flavor-loaded cryoground rapeseeds | 1.00 | |
| Liquid flavor | | 0.2 |
| Salt | 0.45 | 0.45 |
| Total | 100.00 | 100.00 |

The sweet crackers of Example 12 and Comparative Example 13 were baked at 200° C. for ten minutes. The sweet crackers were tasted by experienced tasters. The tasters were requested to rank each sample on flavor intensity. The sweet cracker made with the flavor-loaded, cryogenically-ground rapeseed exhibited a much more authentic flavor profile, and retained more of the flavor' s volatile components as compared to the sweet cracker made with the liquid flavor.

While the active component delivery systems, the compositions, formulations and products containing the active component delivery systems, and methods of making the active component delivery systems and compositions formulations and products containing the active component delivery systems, have been described in connection with various embodiments, it is to be understood that other similar embodiments may be used or modifications and additions may be made to the described embodiments for performing the same function. Furthermore, the various illustrative embodiments may be combined to produce the desired results. Therefore, the flavor capsules, the food products including the flavor, and methods of making the flavor capsule and food products should not be limited to any single embodiment, but rather construed in breadth and scope in accordance with the recitation of the appended claims. It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

1. An active component delivery system comprising cryogenically comminuted plant material and an active component added to said cryogenically comminuted plant material.

2. The active component delivery system of claim 1, wherein said cryogenically comminuted plant material comprises at least one of protein bodies, oil bodies, and starch bodies derived from plant seeds.

3. The active component delivery system of claim 2, wherein said active component is encapsulated or entrapped in at least one of said protein bodies, oil bodies and starch bodies.

4. The active component delivery system of claim 2, wherein said plant seeds are selected from the group consisting of almond seeds, argan seeds, borage seeds, coconut, corn seeds, cotton seeds, chia seeds, cranberry seeds, flax seeds, grape seeds, hemp seeds, linseed, millet, mustard seeds, oil palm, pumpkin seeds, quinoa, rapeseeds, raspberry seeds, safflower seeds, sesame seeds, sunflower seeds, soybeans, and combinations thereof.

5. The active component delivery system of claim 4, wherein said plant seeds are rapeseeds.

6. The active component delivery system of claim 1, wherein said active component is selected from the group consisting of flavors and fragrances.

7. The active component delivery system of claim 6, wherein said active component comprises at least one flavor.

8. The active component delivery system of claim 6, wherein said active component comprises at least one fragrance.

9. The active component delivery system of claim 1, comprising from about 0.1 to about 10 weight percent of said active component and from about 90 to about 99.9 weight percent of said cryogenically comminuted plant material.

10. A food product comprising an edible food base and an active component delivery system therein, wherein said active component delivery system comprises cryogenically comminuted plant material comprising at least one of protein bodies, oil bodies and starch bodies and at least one flavor component encapsulated or entrapped within at least one of said protein bodies, oil bodies and starch bodies.

11. A method of encapsulating an active component in plant material comprising:
cryogenically cooling said plant material with a cryogen;
comminuting said plant material; and
adding said active component to said comminuted plant material to encapsulate or entrap said active component within at least one of protein bodies, oil bodies or starch bodies of said comminuted plant material.

12. The method of claim 11, further comprising hydrating the plant material and mixing the hydrated plant material with a desired amount of the active component, wherein the active component is encapsulated within at least one of said protein bodies, oil bodies, or starch bodies of said plant material.

13. The method of claim 11, further comprising the step of allowing the cryogenically cooled and comminuted plant material to return to room temperature before adding the active component to the comminuted plant material.

14. The active component delivery system of claim 1, wherein the amount of the active component is from about 0.1% to about 10% by weight of the active component delivery system.

15. The active component delivery system of claim 1, wherein the amount of the cryogenically comminuted plant material is about 90% to about 99.9% by weight of the active component delivery system.

16. The food product of claim 10, wherein the food product is a vegetarian or vegan food product.

17. A beverage product comprising an edible or ingestible beverage base component and at least one active component delivery system as defined in claim 1.

18. An oral or personal care product comprising a base component and at least one active component delivery system as defined in claim 1.
